(19) United States
(12) Patent Application Publication
(10) Pub. No.: US 2019/0222371 A1
(43) Pub. Date: Jul. 18, 2019

(54) CODE-DOMAIN NON-ORTHOGONAL MULTIPLE ACCESS SCHEMES

(71) Applicant: IDAC Holdings, Inc., Wilmington, DE (US)

(72) Inventors: Alphan Sahin, Westbury, NY (US); Erdem Bala, East Meadow, NY (US); Mihaela C. Beluri, Jericho, NY (US); Rui Yang, Greenlawn, NY (US)

(73) Assignee: IDAC Holdings, Inc., Wilmington, DE (US)

(21) Appl. No.: 16/300,195

(22) PCT Filed: May 8, 2017
(86) PCT No.: PCT/US2017/031500

§ 371 Date: Nov. 9, 2018

Related U.S. Application Data
(60) Provisional application No. 62/334,719, filed on May 11, 2016.

(51) Int. Cl. H04L 5/00; H04L 27/34; H04L 27/26; H04W 76/27; H04L 1/00

(52) U.S. Cl. CPC H04L 5/0021; H04L 27/3416; H04L 1/0068; H04W 76/27; H04L 27/2636

(57) ABSTRACT

A method for increasing the efficiency and robustness of non-orthogonal multiple access (NOMA) schemes may include storing relationships that associate codewords with values of bit sets, receiving information bits and converting the information bits into bit sets, determining codewords associated with the bit sets, and transmitting the determined codewords. A first codeword may be pre-defined for a WTRU. A second codeword associated with a first bit set may be determined using a first relationship between the first codeword and a value of the first bit set. A third codeword associated with a second bit set may be determined using a second relationship between the second codeword and a value of the second bit set.

### CROSS-REFERENCE TO RELATED APPLICATION

This application claims the benefit of U.S. Provisional Patent Application No. 62/334,719, filed May 11, 2016, the contents of which is incorporated by reference.

### BACKGROUND

Mobile communications continue to evolve. A fifth generation may be referred to as 5G. A previous (legacy) generation of mobile communication may be, for example, fourth generation (4G) long term evolution (LTE).

### SUMMARY

Systems, procedures, and instrumentalities are disclosed for differential encoding that may be used with code-based NOMA schemes.

A WTRU may store (e.g., in a memory) relationships that associate codewords with values of bit sets. The WTRU may use the relationships to determine codewords for information to be transmitted. The WTRU may receive information bits (e.g., a processor may receive information bits associated with a transmission) and convert the information bits into bit sets. The WTRU may determine codewords associated with the bit sets using the stored relationships. The WTRU may transmit the determined codewords.

The WTRU may use and/or perform one or more of the following, e.g., to determine codewords associated with the bit sets using the stored relationships. A first codeword may be pre-defined for the WTRU. The WTRU may determine a second codeword associated with a first bit set using a first relationship between the first codeword and a value of the first bit set. The WTRU may determine a third codeword associated with a second bit set using a second relationship between the second codeword and a value of the second bit set. The first relationship between the first codeword and the value of the first bit set may define a first transition between the first codeword and the second codeword. A second relationship between the second codeword and the value of the second bit set may define a second transition between the second codeword and the third codeword. The relationships may define transitions from a current codeword to a next codeword, e.g., based on the values of the bit sets. A transition may indicate that the first codeword and the second codeword are different or the same, e.g., have different values or same values, as defined by an associated relationship.

### BRIEF DESCRIPTION OF THE DRAWINGS

FIG. 1A is a system diagram of an example communications system in which one or more disclosed embodiments may be implemented.

FIG. 1B is a system diagram of an example WTRU that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and another example core network that may be used within the communications system illustrated in FIG. 1A.

FIG. 1E is a system diagram of another example radio access network and another example core network that may be used within the communications system illustrated in FIG. 1A.

FIG. 2 is an example of a high level block diagram of a transmitter for code-domain based NOMA schemes.

FIG. 3 is an example of a high level block diagram of a transmitter for code-domain based NOMA schemes using multi-dimensional modulation.

FIG. 4 is an example of a Discrete Fourier Transform (DFT)-s-Orthogonal Frequency Division Multiplexing (OFDM) code-domain based NOMA transmitter.

FIG. 5 is an example of a DFT-s-OFDM code-domain based NOMA transmitter.

FIG. 6 is an example of concatenation of codewords or spread sequences prior to DFT operation.

FIG. 7 is an example of a DFT-s-OFDM code-domain based NOMA receiver.

FIG. 8 is an example of DFT based code generation with puncturing of the DFT output.

FIG. 9 is an example of a transmit chain using DFT based NOMA encoding.

FIG. 10 is an example of a transmit chain using DFT based NOMA encoding.

FIG. 11 is an example of code generation with fixed puncturing and sparse mapping.

FIG. 12 is an example of codeword generation preserving DFT-s output.

FIG. 13 is an example of a high level block diagram of a differential encoded code-based NOMA scheme.

FIG. 14 is an example of differential encoding for code-based NOMA schemes. FIG. 14 shows an example of a state machine with M=4 states.

FIG. 15 is an example of differential encoding for code-based NOMA schemes. FIG. 14 shows an example of a state machine with M=8 states.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

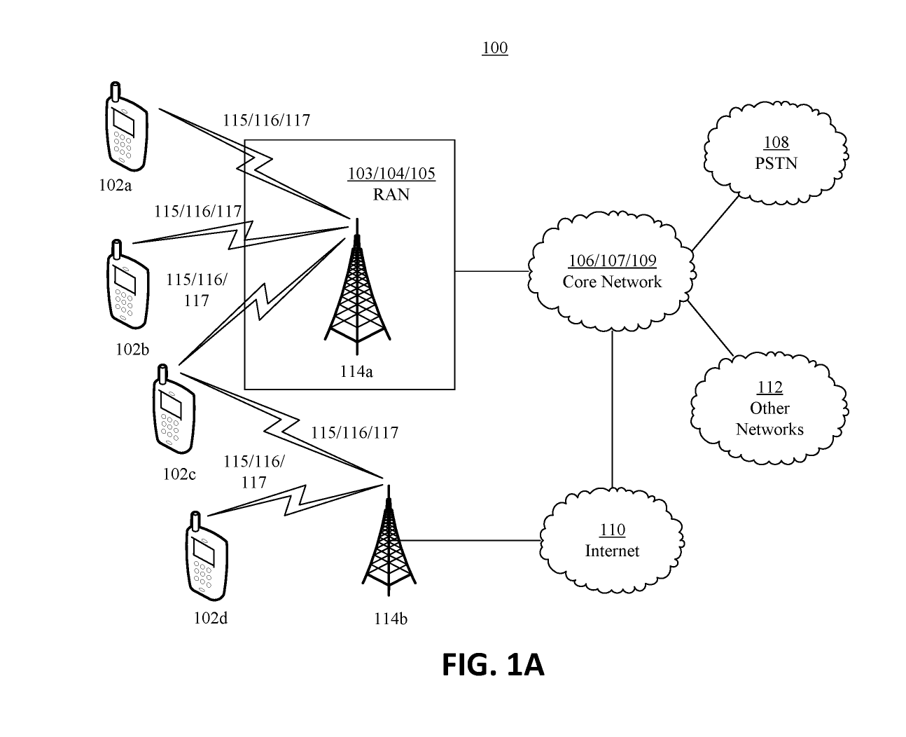

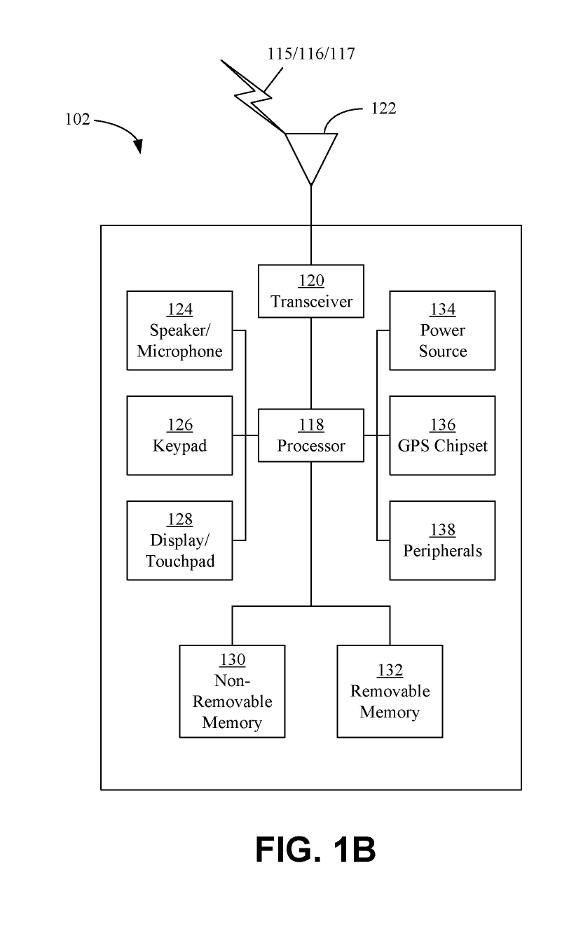

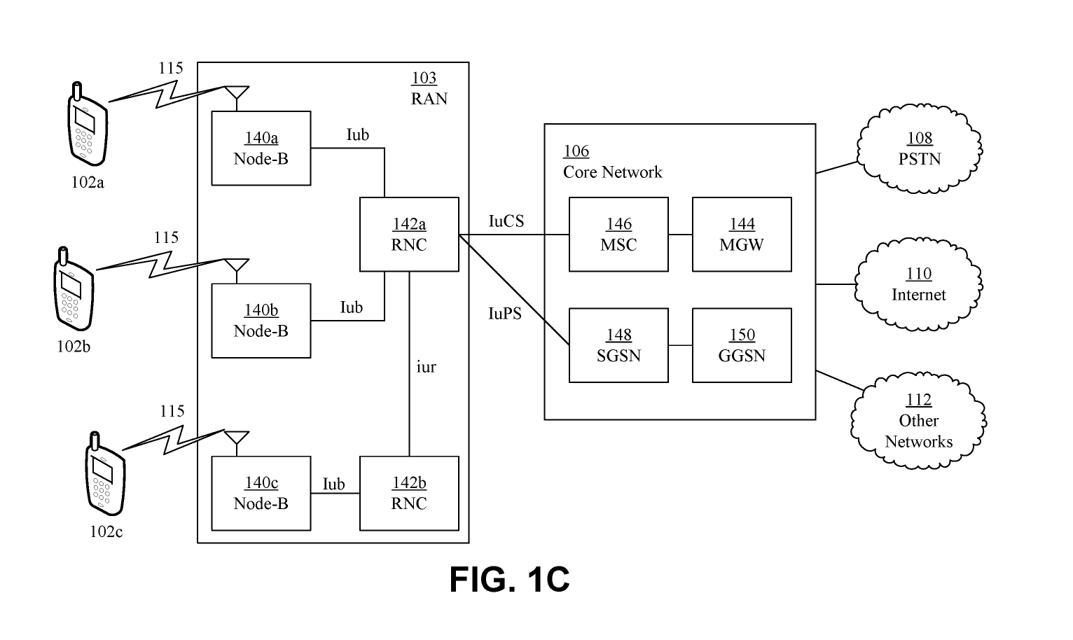

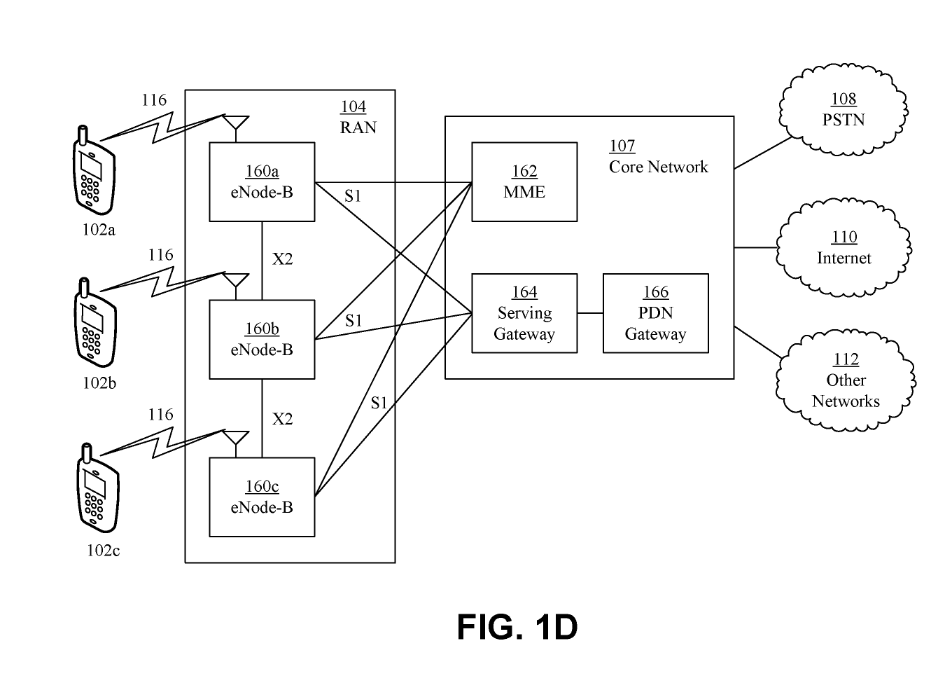

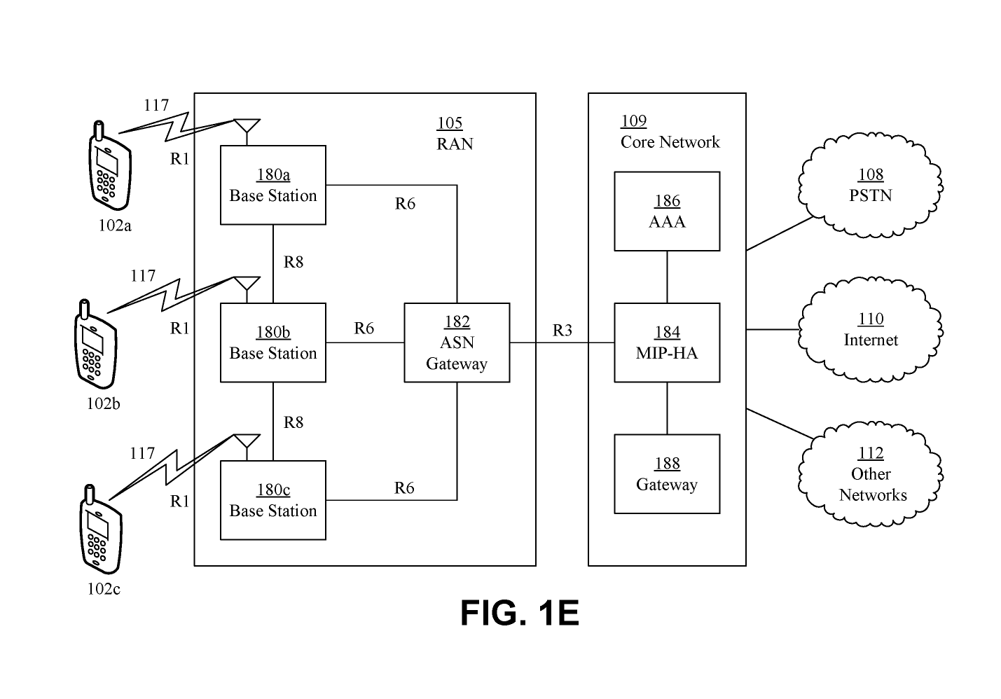

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs), e.g., WTRUs, 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in some embodiments, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In some embodiments, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB or HeNodeB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in some embodiments, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in some embodiments, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination implementation while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In some embodiments, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an Si interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the Si interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In some embodiments, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The importance of supporting higher data rates, lower latency and massive connectivity continues to increase, e.g., for emerging applications for wireless (e.g., cellular) technology. For example, a mobile communication system (e.g., a 5G system) may support enhanced Mobile BroadBand (eMBB) communications, Ultra-Reliable and Low-Latency Communications (URLLC), and/or massive Machine Type Communications (mMTC). Radio access capabilities may differ in importance across a broad range of applications and usage scenarios.

For example, spectral efficiency, capacity, user data rates (e.g., peak and/or average) and mobility may be of relatively high importance for eMBB usage. Multiple access (MA) techniques may improve spectral efficiency, e.g., for eMBB.

Connection density may be of relatively high importance for mMTC. Multiple access techniques may support a massive number of connected terminals that may use short data burst transmissions and may use low device complexity, low power consumption and/or extended coverage. The effectiveness of multiple access techniques in a radio access network may become increasingly important considering support for a variety of applications with a variety of goals.

Some multiple access schemes that may be used in wireless cellular communication systems may assign time/frequency/spatial resources, such that a (e.g., each) user signal may not interfere with other user signals. This type of access may be referred to as Orthogonal Multiple Access (OMA), where multiplexing the users on orthogonal resources may be performed in the time domain (TDM), in the frequency domain (FDM) or in the spatial domain (SDM).

Non-orthogonal multiple access (NOMA) schemes may allocate non-orthogonal resources to users. NOMA may be implemented to address one or more aspects of wireless communications, such as high spectral efficiency and massive connectivity.

A NOMA scheme may multiplex users in the power-domain. Different users may be allocated different power levels, for example according to the channel conditions for the users. Different users that use different power levels may be allocated and/or may use the same resources (e.g., in time and/or frequency). Successive interference cancellation (SIC) may be used at a receiver, for example, to cancel multi-user interference.

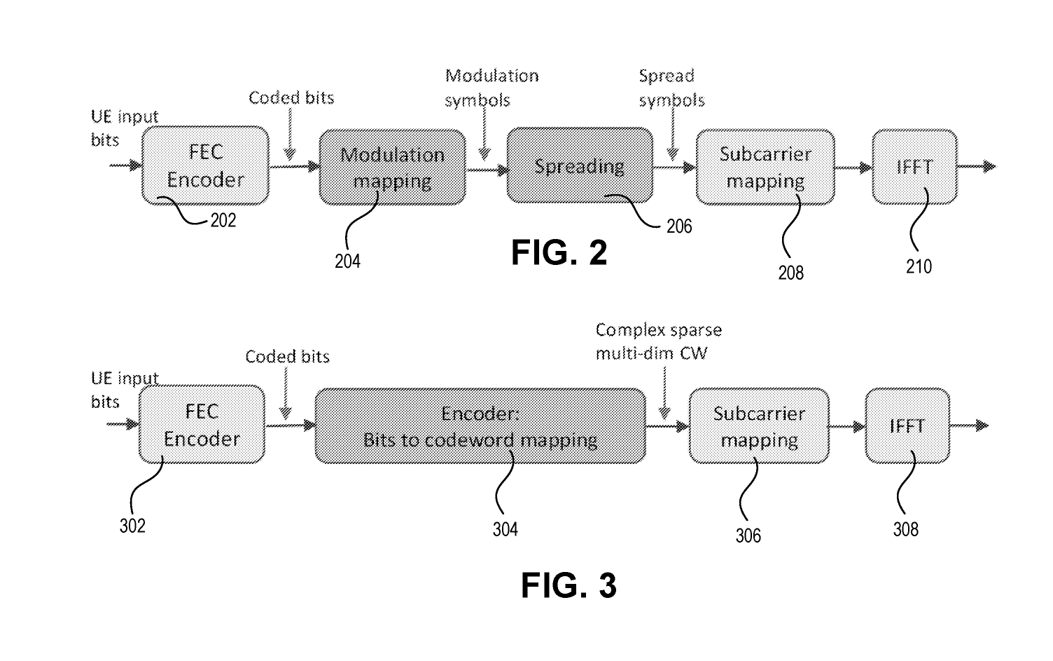

A NOMA scheme may multiplex users in the code-domain. For example, different users may be assigned different spreading codes and may be multiplexed over the same time-frequency resources. FIG. 2 is an example of a high level block diagram of a transmitter for code-domain based NOMA schemes. The example in FIG. 2 may include one or more of FEC encoder 202, modulation mapping 204, spreading 206, subcarrier mapping 208, or IFFT 210. UE input bits may be the input of the FEC coder 202. The FEC coder 202 may output coded bits, which may be the input for modulation mapping 204. The output of the modulation mapping 204 may be modulation symbols that are input to the spreading 206. The output of the spreading may be4 the spread symbols that are inputs to the subcarrier mapping 208. Code-domain multiplexing schemes may benefit from spreading gain, for example, when spreading sequences are longer and non-sparse. Spreading sequences that may be longer and non-sparse may result in a high peak-to-average power ratio (PAPR).

A code-domain multiplexing scheme may benefit from constellation shaping gain, for example, when the scheme uses multi-dimensional modulation. Maximum Likelihood (ML) algorithms or Message Passing Algorithms (MPA) may be used at a receiver, for example, to receive individual user data signals. The ML and/or the MPA algorithms may use channel state information (CSI), for example, to receive user data signals. FIG. 3 is an example of a high level block diagram of a transmitter for code-domain based NOMA schemes using multi-dimensional modulation. The example in FIG. 3 may include one or more of FEC encoder 302, bits-to-codeword-mapping encoder 304, subcarrier mapping 306, or IFFT 308. UE input bits may be the input of the FEC coder 302. The FEC coder 302 may output coded bits, which may be the input for the bits-to-codeword-mapping encoder 304. The output of the bits-to-codeword-mapping encoder 304 may be complex sparse multidimensional codeword that may be input to subcarrier mapping 306.

Massive machine type communication systems (mMTC) may provide massive connectivity, low power consumption and/or extended coverage. The massive connectivity may incur overloading resources. Code-domain NOMA schemes may enable high overloading factors. Code-domain NOMA schemes may use Orthogonal Frequency Division Multiplexing (OFDM) as an underlying waveform, e.g., as shown in examples in FIG. 2 and FIG. 3. An OFDM waveform may have high PAPR. High PAPR may reduce an efficiency of a power amplifier and/or may impact power consumption. Power consumption may be a design factor for battery-operated WTRUs.

MPA receivers for code-domain NOMA schemes may rely on knowledge of channel information. The reliance on the knowledge of channel information may make MPA receivers sensitive to channel estimation errors.

PAPR may be reduced for code-domain NOMA schemes, e.g., for short and long codes. System robustness to channel estimation errors may be improved.

In an example (e.g., for code-domain NOMA schemes using multi-dimensional modulation), codewords may be transmitted, for example, using a Discrete Fourier Transform (DFT)-spread-OFDM (DFT-s-OFDM) waveform. The DFT-s-OFDM waveform may reduce PAPR, reduce power consumption, etc.

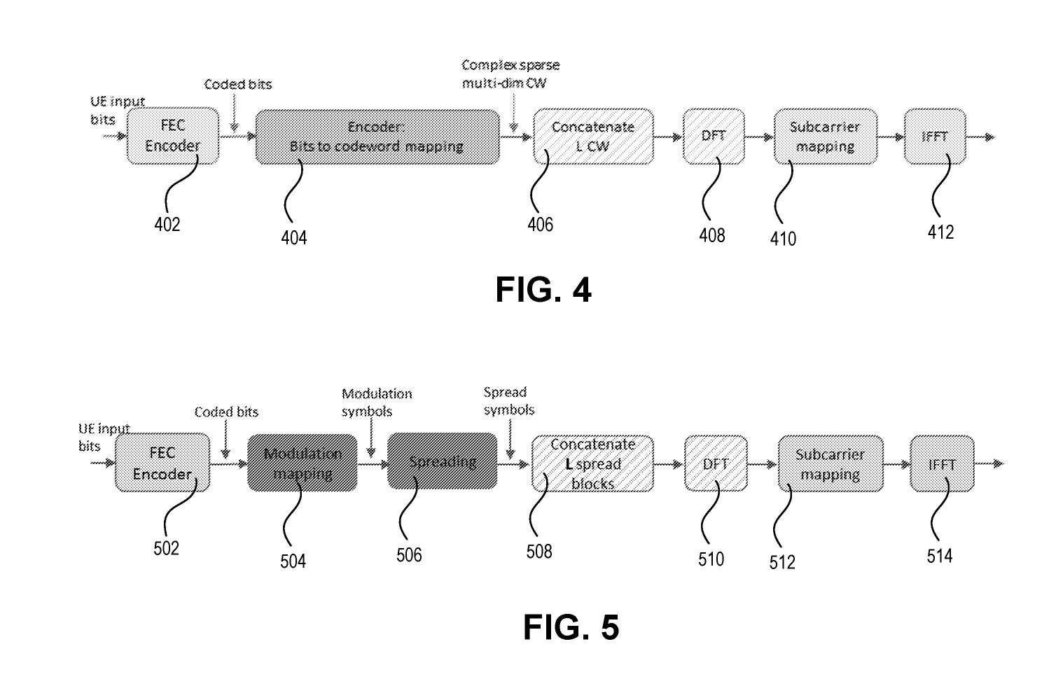

FIG. 4 is an example of a DFT-s-OFDM code-domain based NOMA transmitter. For example, coded bits may be mapped to complex codewords. The example in FIG. 4 may include one or more of FEC encoder 402, bits-to-codeword-mapping encoder 404, concatenate L CW 406, DFT 408, subcarrier mapping 410, or IFFT 412. UE input bits may be the input of the FEC coder 402. The FEC coder 402 may output coded bits, which may be the input for the bits-to-codeword-mapping encoder 404. The output of the bits-to-codeword-mapping encoder 404 may be complex sparse multidimensional codeword that may be input to concatenate L CW 406. One or more codewords may be concatenated and fed as an input to a DFT block 408. Output of the DFT block 408 may be mapped to correct inputs of an Inverse Fast Fourier Transform (IFFT) block 412, for example, so that data may be transmitted on assigned subcarriers.

In an example, spread symbols may be transmitted using a DFT-s-OFDM waveform as shown in FIG. 5, which may reduce PAPR. FIG. 5 is an example of a DFT-s-OFDM code-domain based NOMA transmitter. The example in FIG. 5 may include one or more of FEC encoder 502, modulation mapping 504, spreading 506, Concatenate L spread blocks 508, DFT 510, subcarrier mapping 512, or IFFT 514. UE input bits may be the input of the FEC coder 502. The FEC coder 502 may output coded bits, which may be the input for the modulation mapping 504. The output of the modulation mapping 504 may be modulation symbols that may be the input for the spreading block 506. The spread symbols may be the output of the spreading block 506, which may be fed to the Concatenate L spread blacks 508. For example, one or more blocks of spread symbols may be concatenated and fed as input to DFT block 510.

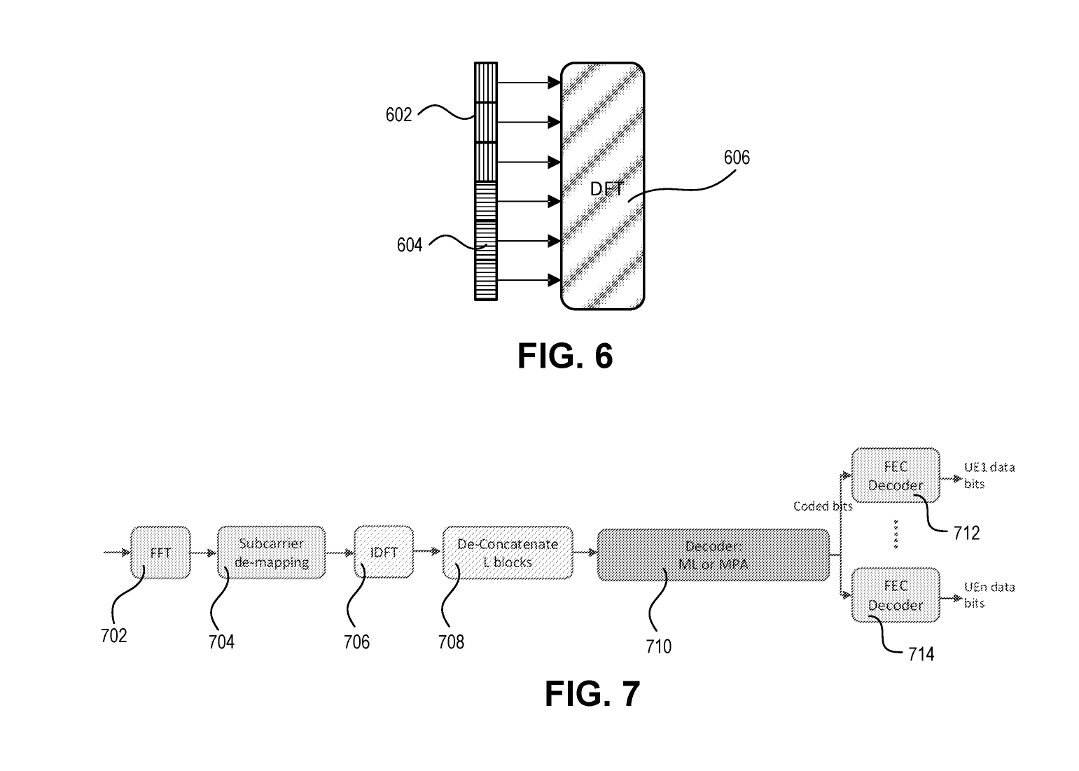

FIG. 6 is an example of concatenation of codewords or spread sequences prior to DFT operation. FIG. 6 may show an example of two (2) concatenated codewords or spread sequences. A first codeword or spread sequence 604 is indicated by horizontal hatching and a second codeword or spread sequence 602 is indicated by vertical hatching. The two codewords 602 and 604 (e.g., each of the two codewords) in this example may have a length of three (3) as indicated by segmentation lines. The codewords or spread sequences 602 and 604 may be fed to a DFT block 606. The two codewords 602 and 604 may be combined during DFT (e.g., DFT block 606). In an example, a number of zeros may be applied at the tail and/or head input of the DFT block, for example, to use a concatenated code-domain NOMA scheme with a Zero Tail (ZT) DFT-s-OFDM waveform, which may reduce out-of-band (OOB) emissions. In an example, a concatenated code-domain NOMA scheme may be used in conjunction with a Unique Word (UW) DFT-s-OFDM waveform, which may reduce PAPR and OOB emissions and may facilitate receiver synchronization.

FIG. 7 is an example of a DFT-s-OFDM code-domain based NOMA receiver. In an example shown in FIG. 7, a receiver may, for example, apply FFT processing 702, subcarrier de-mapping 704, Inverse DFT (IDFT) 706, codeword or L block de-concatenation 708 and/or multiuser detection based on ML or MPA decoder 710. The output of the ML or MPA decoder 710 may be coded bits. The code bits may be fed to multiple FEC decoders including FEC decoder 712 to FEC decoder 714. The FEC decoder 712 may output data bits for user 1. The FEC decoder 714 may output data bits for user n.

Multiuser detection algorithms for code-based NOMA schemes (e.g., ML or MPA) may use a channel response (e.g., per codeword) to detect the codewords. Detection may be performed (e.g., for OFDM waveforms) in the frequency domain, for example, after the FFT operation. For example, the effective channel response per subcarrier may be approximated by a (e.g., single) complex number. A channel response coefficient for a codeword in a DFT-s-OFDM based waveform (e.g., after IDFT block receiver processing) may have contributions from some or all sub-channels.

The number of subcarriers may be selected, for example, to prevent the channel response from changing significantly over the range of the used subcarriers. The selected number of subcarriers may allow using the same channel coefficient and/or the approximation of the channel response on the selected subcarriers (e.g., each of the selected subcarriers). The channel coefficient may be used in a multiuser detection algorithm. The channel response for an (e.g., each) element of the codeword may be approximated by the same channel coefficient. The number of subcarriers allocated may vary, for example, depending on the channel characteristics. For example, more subcarriers may be used in low delay spread channels because the channel varies more slowly in the frequency domain.

Resource allocation may be provided. Codebooks and codewords therein, subcarriers, etc. may be resources that may be allocated, for example, to network nodes, such as WTRUs, to communicate over the network.

A codeword may include one or more of the following: a codeword selected (e.g., directly) by a number of data bits (e.g., as in multidimensional modulation), a spreading sequence that may multiply a data symbol (e.g., QAM modulated symbol), or any other ordered set of coefficients that map a number of data bits and/or symbols to a vector. A codebook may include a collection of codewords. Different codewords may indicate different sets of resources (e.g., physical resources). A codeword may have a length (e.g., a specific length). For example, a codeword may include a vector of k complex numbers. A codebook may contain codewords of the same size and/or codewords of different sizes.

Mapping data bits and/or symbols to codewords may, for example, be predefined, configured (e.g., by a central controller), signaled (e.g., by a central controller) to a network node (e.g., a WTRU) and/or determined (e.g., autonomously) by a node (e.g., a WTRU).

Table 1 and Table 2 present examples of mapping data bits to codewords.

TABLE 1
Example of mapping data bits to codewords

| Data bits | Codeword |
|---|---|
| 00 | C11 |
| 01 | C21 |
| 10 | C31 |
| 11 | C41 |

TABLE 2
example of mapping data bits to codewords

| Data bits | Codeword |
|---|---|
| 00 | C12 |
| 01 | C22 |
| 10 | C32 |
| 11 | C42 |

The mapping may be signaled, for example, with log₂ (N) bits, where N may be the number of mappings (e.g., tables). For example, there may be four different tables for the mapping of 2 bits, 3 bits, 4 bits and 5 bits of data to a codeword. The mapping shown in Table 1 may be signaled with log₂ (N) bits. Any one of these four mappings may be signaled with 2 bits in a control message. The contents of the four mapping tables may be different (e.g., partly or entirely different) for different WTRUs. The tables may be configured, for example, by a central controller. Configuration of the mapping may be based on, for example, a feedback from a WTRU. The feedback may comprise, for example, channel quality information. The channel quality information may be transmitted in a control message or reference signals, such as sounding reference signals.

Multiple (e.g., two or more) codebooks may be used for the same data bits and/or symbols. For example, the codewords in Table 1 may form one codebook, and the codewords in Table 2 may form another codebook. Codewords in Table 1 may be of size-k while codewords in Table 2 may be of size 2k. A transmitter may use Table 1 or Table 2 based on the channel conditions. The codebooks may be indicated with log₂ (K) bits, where K may be the number of the codebooks. For example, possible codebooks may be indicated with log₂ (K) bits, where K may be the number of the possible codebooks. In one or more examples, one or more codebooks may be indicated as candidate codebooks and a selection of a codebook among the one or more codebooks may be signaled. A codebook among the codebooks that maps the same data bits/symbols to codewords may be (e.g., first) configured as a candidate codebook. For example, Table 1 and Table 2 may have been firstly configured as candidate codebooks and selected later by log₂ (2) bits. One or more candidate books may be configured. A selection of a codebook(s) among the candidate codebooks may be signaled, for example, by log₂ (N) bits, where N may be the number of candidate codebooks. For example, it may be assumed that the codewords in Table 1 have 4 coefficients while the codewords in Table 2 have 12 coefficients. In example, the codewords in Table 1 may be used by a WTRU with a higher signal-to-noise and interference ratio (SINR) while the codewords in Table 2 may be used by coverage-limited WTRUs. A decision about which codebook to use may be made, for example, by a central controller or (e.g., autonomously) by a node (e.g., a WTRU).

A WTRU may autonomously determine (e.g., select) a codebook, for example, from a set of candidate codebooks. For example, the WTRU may autonomously determine a codebook in a grant-free communication. A set of candidate codebooks for the WTRU to select from may be configured, for example, by a central controller. For example, the set of candidate codebooks for the WTRU may be configured at the time of initial connection by the WTRU.

A WTRU may transmit (e.g., start transmission), for example, using one of candidate codebooks and may change the codebook for one or more reasons that may be based on one or more types of information. For example, a codebook change may be based on feedback or lack of feedback from a receiver. In an example, a WTRU may start transmission using the codebook in Table 1 and may change to using the codebook in Table 2, for example, when an acknowledgment is not received for transmission using the codebook in Table 1.

A codeword used for transmission may be signaled to a receiver (e.g., in a control message) or blindly detected by the receiver. The receiver may blindly detect the codeword used for transmission among the codewords in the set of candidate codebooks. A size of a codeword may be determined based on information (e.g., existing information) in a control message and/or configured parameters. In an example, a number of subcarriers allocated for an OFDM transmission may be M and the number of data bits may be L. The size of codewords may be determined, for example, as M/(L/2).

A codebook of codewords may be generated, for example, based on a DFT matrix. For example, input to a DFT matrix may be a vector x that may be used to generate the transmitted codeword. Input vector x may be determined, for example, as a function of information bits to be transmitted. Input vector x may be WTRU specific. For example, input vector x may be different for a different WTRU. An output of the DFT matrix or block may a vector y, which may be written as y=Fx, where F may be an M-size DFT matrix and x may be the input vector.

A codebook of one or more codewords may be generated, for example, by puncturing the output of the DFT block. The output of the DFT block may be vector y as described herein. For example, a puncturing operation may set some rows of the output of the DFT block (e.g., vector y) to zero. The output of the DFT block may be punctured in some locations that may, for example, enable multiplexing multiple users on the same resources. A puncturing pattern (e.g., the codebook) may be WTRU specific. For example, puncturing patterns may be different for different WTRUs. A puncturing pattern may be determined, for example, by a central controller and may be signaled to a WTRU. A puncturing pattern may (e.g., alternatively, additionally, selectively, conditionally, etc.) be determined (e.g., autonomously) by a WTRU.

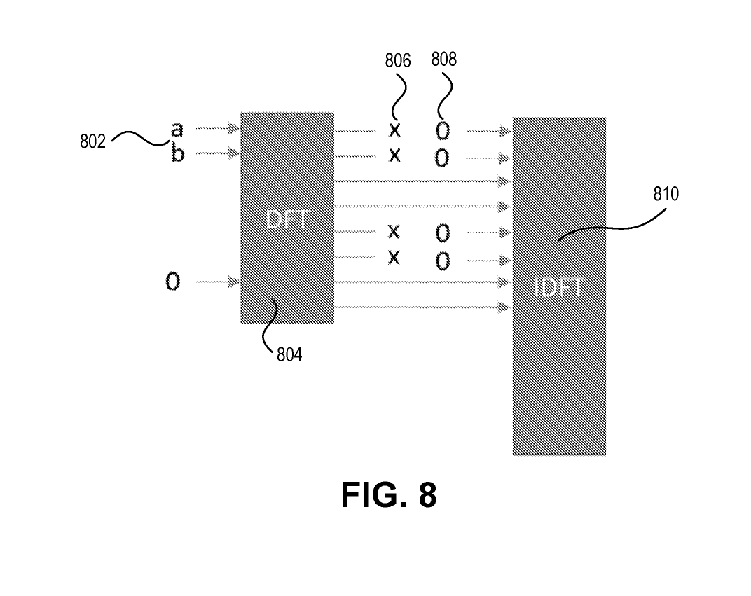

FIG. 8 is an example of DFT based code generation with puncturing of the DFT output. FIG. 8 shows an example of DFT 804 based code generation where input vector [a b] 802 is the input to the DFT matrix and may include 1's and 0's. The input vector [a b] 802 may depend on the bits to be transmitted (e.g., user bits, information bits or coded bits). In an example, an information bit “0” to be transmitted may map to [a b]=[1 0], while an information bit of “1” to be transmitted may map to [a b]=[0 1]. In an example (e.g., as shown in FIG. 8), F may be an 8×8 DFT matrix 804, input vector x 802=[a b 0 0 0 0 0 0]^{T}, punctured outputs may be denoted with an “x” 806 and the corresponding inputs 808 applied to the IDFT 810 (e.g., IFFT) matrix may be set to 0.

Codeword generation may include, for example, a linear combination of columns of a DFT matrix. The linear combination of columns of a DFT matrix may be selected by non-zero elements of input vector x and/or followed by selected or targeted puncturing of the output of the DFT matrix.

Code parameters that may be determined or controlled with the approaches for generating codebooks and codewords herein may include one or more of the following: the number of codewords per codebook, codewords within a codebook, codeword length, codebook or the number of codebooks. The number of codewords per codebook may be determined or controlled, for example, by the length of the x vector at the input of the DFT block. Codewords within a codebook may be determined or controlled, for example, by the values of the elements of the x vector (which may be binary, real or complex) and/or by the size (M) of the DFT block. Codeword length may be determined or controlled, for example, by the size (M) of the DFT block. The codebook may be determined or controlled, for example, by the selected puncturing pattern, the sparsity of the codewords, and/or by the indices of the non-zero elements of the x vector. The sparsity of the codewords may be controlled by the number of elements of the vector y that are punctured. The indices of the non-zero elements of the x vector may be different for the vector x=[a b 0 0 0 0 0 0]^{T} and vector x=[0 0 a b 0 0 0 0]^{T}. The vector x=[a b 0 0 0 0 0 0]^{T} may generate a different codebook compared to the vector x=[0 0 a b 0 0 0 0]T. A number of codebooks may determine an overloading factor, e.g., how many users may be supported).

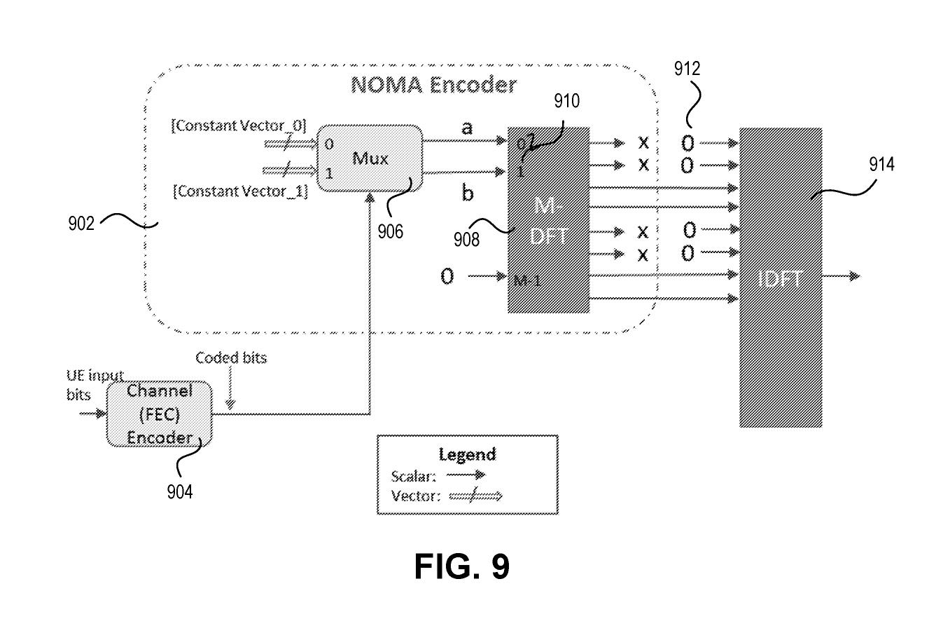

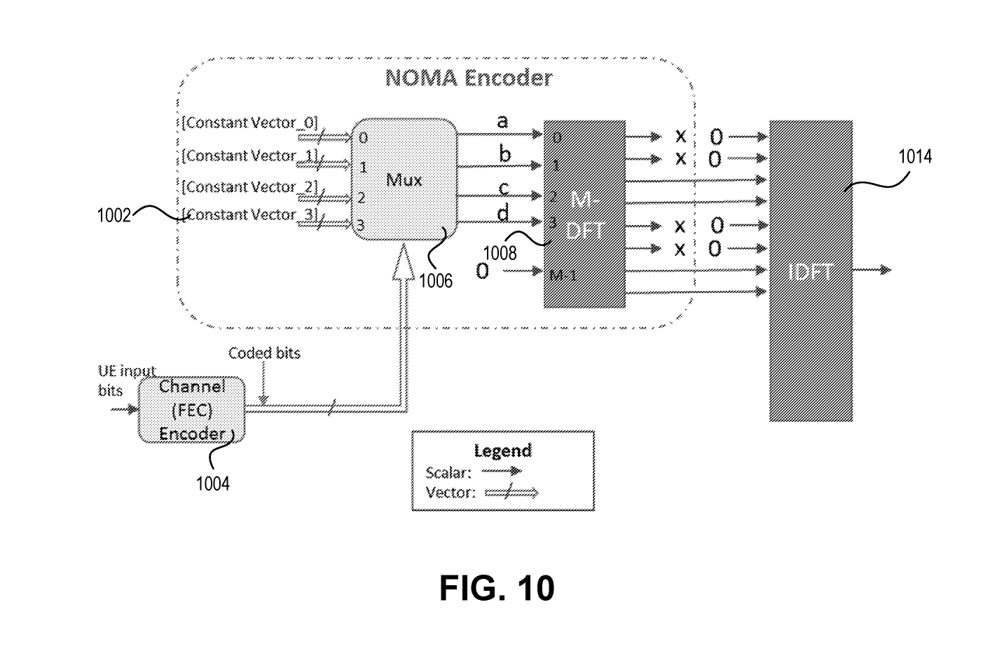

FIG. 9 is an example of a transmit chain using DFT based NOMA encoding. The example in FIG. 9 (e.g., with one active input) may include a NOMA encoder 902, a channel FEC encoder 904, and IDFT block 914. The NOMA encoder 902 may include a multiplexer 906 and M-DFT 908. The NOMA encoder 902 may be used in the transmitter chain. In an example, the output of the multiplexer 906 [a b] may be given by:

$$[ a b ] = \{ \begin{matrix}Constant {Vector}_{0} , when channel encoder bit = ‘ 0 ’ \\ Constant {Vector}_{1} , when channel encoder bit = ‘ 1 ’\end{matrix}$$

where various codewords may be generated, for example, by appropriately configuring vectors 910 Constant_Vector_0 and Constant_Vector_1. In an example, one or more of the tail inputs of the DFT-s block (e.g., the M-DFT block) may be set to zero as shown by 912 (e.g., a ZT DFT-s OFDM), for example, which may achieve low PAPR and OOB emissions. A form of single carrier (e.g., the DFT-s-OFDM structure) may be used to achieve low PAPR. The zeros at the input of M-DFT may achieve low edge samples of time domain signal, which may reduce OOB emission. The low-energy samples may increase the smoothness of the signals. Multiple active inputs may be used (e.g., at the same time). FIG. 10 is an example of a transmit chain using DFT based NOMA encoding. FIG. 10 shows an example using a 2-bit NOMA encoder (e.g., four combinations) for a DFT-s-OFDM transmitter. The example in FIG. 10 may include a NOMA encoder 1002, a channel FEC encoder 1004, and IDFT block 1014. The NOMA encoder 1002 may include a multiplexer 1006 and M-DFT 1008. Four different constant vectors 1002 may be mapped to inputs of M-DFT by a multiplexer 1006.

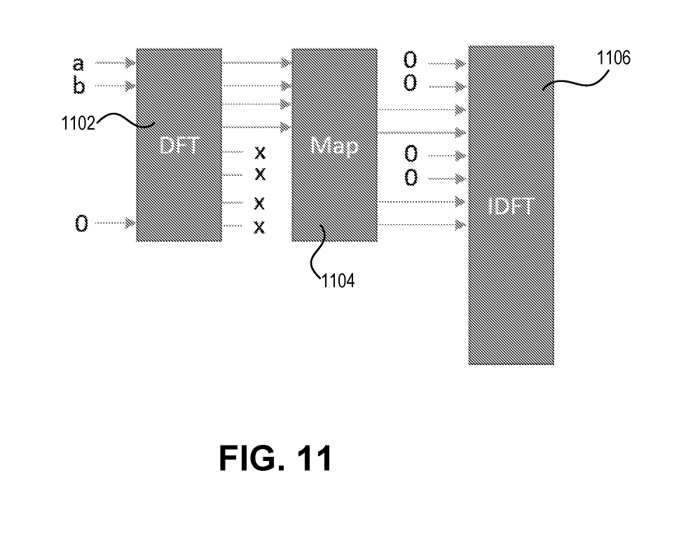

FIG. 11 is an example of code generation with fixed puncturing and sparse mapping. The example in FIG. 11 may include a DFT block 1102, map block 1104, and IDFT block 1106. In an example, a codebook of codewords may be generated, for example, using a fixed puncturing pattern at the output of the DFT block 1102 and a sub-carrier mapping matrix to map non-punctured DFT outputs to a sparse codeword at the input to the IDFT block 1106. A multiplexing matrix may be WTRU-specific. For example, a different multiplexing matrix may be for a different WTRU. A multiplexing matrix may be determined by a central controller and signaled to a WTRU or autonomously determined by the WTRU. In an example as shown in FIG. 11, a size-8 DFT block 1102 may be used. A fixed puncturing pattern may discard the last 4 outputs of the DFT block 1102, and a mapping block 1104 (e.g., sub-carrier mapping) may map the 4 non-punctured DFT outputs to sparse codewords at the input of the IDFT 1106. In this example, the codeword length may be 8.

NOMA code generation with fixed puncturing and sparse mapping may be used with a transmit chain for 1 bit or multiple bit (e.g., 2 bit) encoding, for example, as shown in examples in FIG. 9 and FIG. 10.

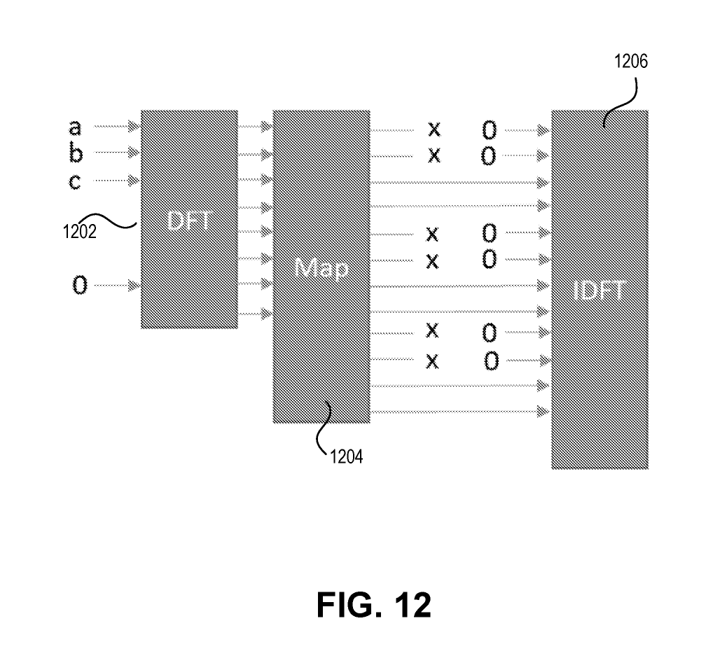

FIG. 12 is an example of codeword generation preserving DFT-s output. FIG. 12 shows an example procedure where the output of the DFT operation may be preserved while the outputs of a multiplexing block may be punctured. The example in FIG. 12 may include a DFT block 1202, Map block 1204, and IDFT block 1206. In an example as shown in FIG. 12, a size-8 DFT block 1202 may be used. The outputs of the DFT block 1102 may be preserved without puncturing, and a mapping block 1204 (e.g., sub-carrier mapping) may map the non-punctured DFT outputs to the input of the IDFT 1206 to generate sparse codewords in frequency. In this example, the codeword length may be 12.

Sizes of DFT matrices that are used to generate codewords may depend, for example, on the number of resources (e.g., subcarriers) allocated for transmission. Puncturing and multiplexing patterns may be WTRU-specific. For example, different puncturing and multiplexing patterns may be used for different WTRUs. Puncturing and multiplexing patterns may be determined by a central controller or autonomously by a WTRU. Other matrices may be used (e.g., additionally or alternatively to a DFT matrix) for codebook generation. For example, an additional or alternative matrix may include a Hadamard matrix, a matrix of randomly generated complex and/or real numbers, etc.

Differential encoding may be used in association with code-based NOMA schemes to enable non-coherent demodulation and/or support massive connectivity. Differential encoding may include encoding information based on a differential between multiple codewords. For example, a differential encoding between two codewords may indicate transmitted data symbol. The codewords may be transmitted on multiple resources and/or multiple sets of resources. For example, the codewords may be transmitted on two adjacent sets of resources (e.g., physical resources). Two adjacent groups of subcarriers may constitute two sets of resources. A group of subcarriers in two adjacent OFDM symbols may constitute two sets of resources.

A differential encoder (e.g., state machine based differential encoder) may be used in association with code-domain NOMA, e.g., to use defined relationships between values of information bits (e.g., information bit sets) and multiple codewords. The differentials between multiple codewords may be indicated by transitions between multiple states of a state machine based differential encoder. An input of a selected bit or bit set may cause the state machine based differential encoder to transition from one state to another state. Different codewords may be transmitted in different resources. For example, the transition from codeword Y to codeword Z may be used to indicate a value of another information bit or another set of information bits. The relationships indicating the transitions between multiple codewords and the values of the information bit or the set of the information bit may be used by a state machine based differential encoder to determine the next codeword.

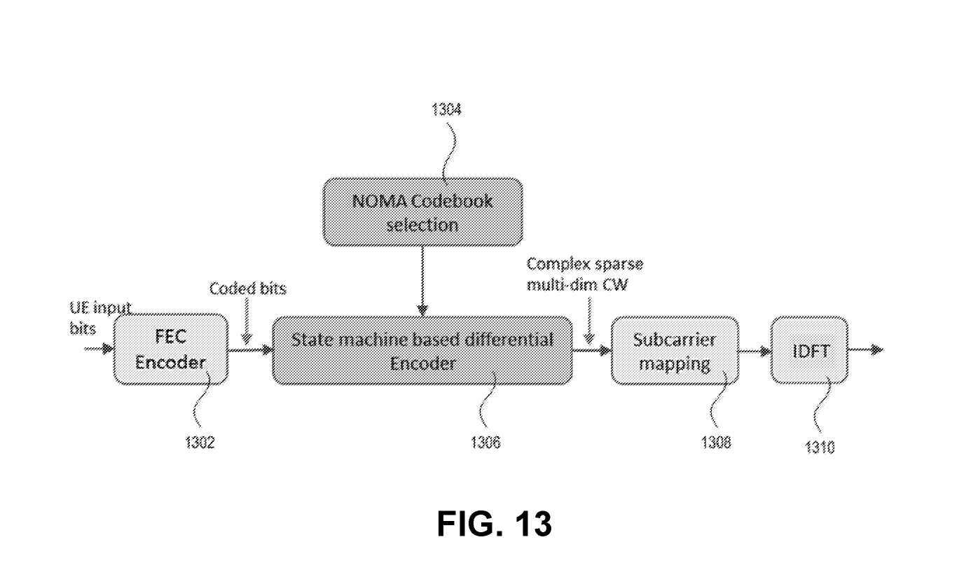

FIG. 13 is an example of a high level diagram of a differential encoded code-based NOMA scheme including a state machine based differential encoder. A NOMA scheme using differential encoding may, for example, use or assign a different codebook for a user (e.g., each WTRU). Differential encoding may be achieved, for example, by a state machine. A m-tuples of bits at an encoder (e.g., a state machine) input may determine transitions between states, which may result in generating codewords as output.

As illustrated in FIG. 13, WTRU input bits may be processed by a FEC encoder 1302. The FEC encoder 1302 may process input bits (e.g., information bits) by the WTRU and output bits or bit sets (e.g., coded bits and/or sets of coded bits). The bits and/or the bit sets and the values of the bits and/or the bit sets may be the input to a state machine based differential encoder 1306. The state machine based differential encoder 1306 may receive NOMA codebook selection 1304. A different codebook may be used or assigned for a different user in the NOMA schemes using differential encoding. The NOMA codebook selection 1304 may include various codewords that may be used by the state machine based differential encoder 1306 to generate a group(s) of codewords (e.g., complex sparse multidimensional codewords). The group(s) of codewords may be the input to a subcarrier mapping function 1308. A number of users (e.g., more than the number of codewords) may use a same set of resources. For example, six users may be assigned on four resource elements (e.g., via the subcarrier mapping function 1308). The group of codewords may be mapped to subcarriers using MPA, for example, and sent to the IDFT 1310 for processing. An example implementation of IDFT 1310 may be IFFT. A codebook assignment and/or state machine for n user (e.g., a WTRU) may be, for example, semi-statically configured via higher layer signaling.

A state machine used for differential encoding may be WTRU-specific or WTRU-group specific, for example, to enable multiple user's transmissions to use the same set of resources. The state machine may define relationships associating the transitions between the codewords and the values of the bit sets. The relationships defined for a first WTRU may differ from relationships defined for a second WTRU. The relationships defined for a first group of WTRUs may differ from relationships defined for a second group of WTRUs.

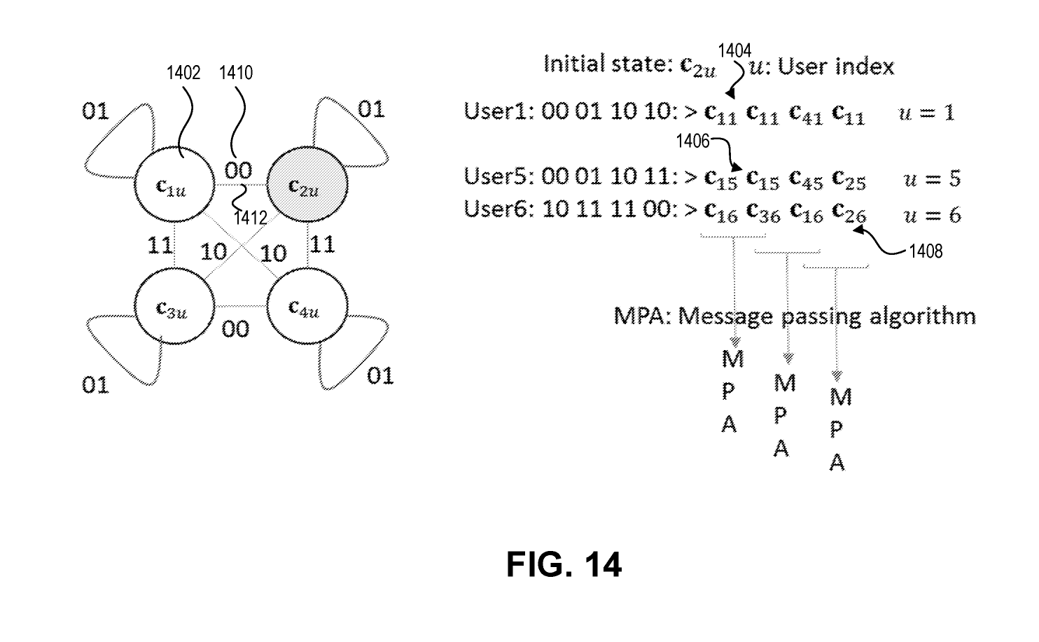

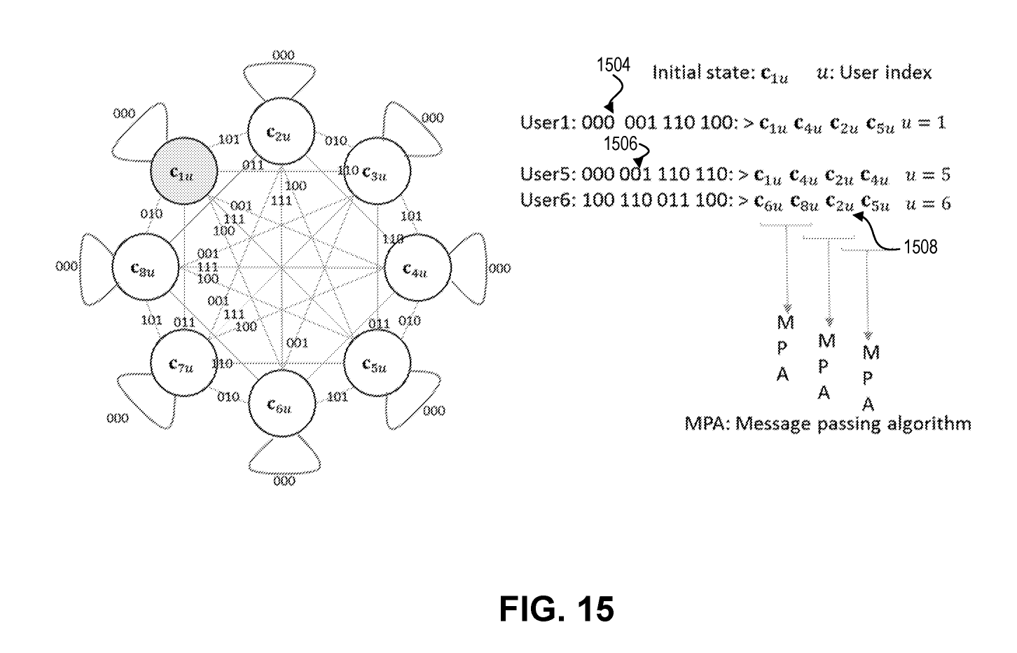

An encoder (e.g., the state machine based differential encoder 1306) may generate and/or store relationships that indicate transitions between multiple codewords based on value(s) of the information bit or the set of the information bits. Information bits may be received and/or converted to sets of information bits. Based on the relationships that indicate the transitions between multiple codewords and the values of the information bit or the set of the information bits, a different sequence of codewords may be assigned to different WTRUs. The state machine may be in a current state or transition to the next state. An input of the information bit or the information bit set may cause the state machine to transition from the current state to the next state or stay (e.g., continue) in the current state (e.g., an input of the information bit or the information bit set may indicate a codeword that may be different from or the same as the current codeword, e.g., see FIGS. 14 and 15).

FIG. 14 is an example of state-machine based differential encoding for code-based NOMA schemes. FIG. 14 shows an example of a state machine with 4 states, e.g., M=4 states, which may be used, for example, to differentially encode 2 bits to select a codeword to be transmitted. For example, the state 1402 may be C₁ᵤ. The transition 1412 may be between C₁ᵤ and C₂ᵤ indicating the value 1410 of information bit set 00. In an example, e.g., as shown in FIG. 14, there may be M=4 codewords per codebook. In an example, e.g., as shown in FIG. 14, there may be J=6 codebooks, for example, where six different users may be multiplexed on the same resources.

A state machine may transition through and/or between a number of states. The number of the states may be associated with the number of bits in associate bit sets. The number of states may be determined based on the number of tuples. The number of tuples may be determined based on the number of bit, bit sets, and/or bit combinations. The value of the bit and/or the bit sets may indicate a state transition. For example, a codeword may be indicated based on a value of a bit or bit set and based on a current state, e.g., a current codeword. For example, a state-machine may include a number of states that may be associated with m-tuple bits (or a bit set). A 2-tuple bits may be indicated by four states. The number of tuples may be m=2, indicating the number of bits in a bit set. The two bits may be 1 and 0. For example, the bit sets may include a combination of two bits with each bit varying between the values 1 and 0. A value of a bit set may include the value of two bits such as 1 and 0. The four states may be used to differentially encode four bit sets and/or four values of the bit sets including 00, 01, 10, and 11. A 3-tuple bits may be indicated by 8 states, as illustrated in FIG. 15.

As illustrated in FIG. 14, codewords C₁ᵤ, C₂ᵤ, C₃ᵤ, and C₄ᵤ may represent four states. Information bits (e.g., the message to be transmitted) may cause transitions between states, e.g., from a first state to a second, third or fourth state, etc. For example, an initial state may be c₁ᵤ, for user “u.” A codeword selected for transmission may be C₁ᵤ, for example, when information bits 01 is to be transmitted while in the initial state, causing the state machine to maintain the initial state. A codeword selected for transmission may be C₂ᵤ, for example, when information bits 00 is to be transmitted while in the initial state, causing a transition from C₁ᵤ to C₂ᵤ. A codeword selected for transmission may be C₃ᵤ, for example, when the information bits 11 is to be transmitted while in the initial state, causing a transition from C₁ᵤ to C₃ᵤ. A codeword selected for transmission may be C₄ᵤ, for example, when the information bits 10 is to be transmitted while in the initial state, causing a transition from C₁ᵤ to C₄ᵤ.

As illustrated in FIG. 14, for user 1, an initial state may be determined to be C₂ᵤ where u=1, meaning an initial state for user 1 may be C₂₁. In an example, e.g., shown in FIG. 14, a bit set with value 00 may be transmitted while in the initial state of C₂₁. The state machine may transition (e.g., the first transition) from C₂₁ to C₁₁, which may result in the transmitted codeword being C₁₁ for information bits 00. While in state C₁₁, a bit set with value 01 may cause the state machine to transition (e.g., the second transition) from C₁₁ to C₄₁. As shown in FIG. 14, an input bit sequence may be 00 01 10 10, which may result in the transmitted codewords for user 1 being C₁₁, C₁₁, C₄₁ and C₁₁, respectively. The codewords C₁₁, C₁₁, C₄₁ and C₁₁ may be transmitted to user 1, e.g., via RRC signaling. FIG. 14 also shows examples of sequences of transmitted codewords for user 5 and user 6 for respective input bit sequences.

As illustrated in FIG. 14, the states may be associated with codewords. A codeword may be associated with a user index and/or the states. The user index may indicate a user that the codeword is associated with. In the example shown in FIG. 14, the codewords C₁ᵤ, C₂ᵤ, C₃ᵤ, and C₄ᵤ may be associated with the WTRU u, where u is the user index. The user index u may be 1, 2, 3 etc. indicating user 1, user 2, user 3 etc. For user 1 (e.g., user index u is 1), codewords C₁ᵤ, C₂ᵤ, C₃ᵤ, and C₄ᵤ may be C₁₁, C₂₁, C₃₁, and C₄₁. For user 2 (e.g., user index u is 2), codewords C₁ᵤ, C₂ᵤ, C₃ᵤ, and C₄ᵤ may be C₁₂, C₂₂, C₃₂, and C₄₂. The number 1 for codeword C₁ᵤ, the number 2 for codeword C₂ᵤ, the number 3 for codeword C₃ᵤ, and the number 4 for codeword C₄ᵤ may indicate the states of the state machine. The state machine may be in state 1 indicated by codeword C₁ᵤ. The state machine may transition to state 2 indicated by codeword C₂ᵤ. The state machine may be user specific. For example, for user 1, the state machine may transition from C₁₁ to C₂₁, using codewords for user 1. For user 2, the state machine may transition from C₁₂ to C₂₂ using codewords for user 2. The association of the codewords with the states may be indicated over control channels. For example, the codewords may be assigned or associated with the states before the transmission of the control channels, and the assignment may be indicated over the transmission of the control channels.

The relationships identifying transitions between the codewords based on the values of the bit sets may be used to determine a codeword for a bit set. For example, a next codeword for the bit set may be determined based on a current codeword, a value of a bit set, and the relationship associating the value of the bit set with the transition between the current codeword and the next codeword. As illustrated in FIG. 14, a value of a bit set that includes two bits, for example, 00, may indicate a transition between codeword C₁ᵤ and codeword C₂ᵤ or another transition between codeword C₃ᵤ and codeword C₄ᵤ, which may depend on a current codeword. The corresponding relationships between the value of the bit sets and the transitions between codewords may be summarized in Table 1.

An initial state (e.g., the initial codeword indicating the initial state) may be pre-defined. For example, the initial state and/or the codeword indicating the initial state may be predetermined for some or all users. In the example shown in FIG. 14, the initial codeword may be C₂ᵤ.

Based on Table 1, the next codeword may be C₁ᵤ if the value of the bit set is 00. C₁ᵤ may become the current codeword indicating the current state. The next bit set value 01 may cause the state machine to remain in the current state C₁ᵤ. C₁ᵤ may remain to be the current codeword. The next bit set value 10 may cause the state machine to transition from the current state C₁ᵤ to C₄ᵤ. Following Table 1, a sequence of codewords that signifies values of four bit sets 00, 01, 10, and 10 may be C₁ᵤ, C₁ᵤ, C₄ᵤ, and C₁ᵤ. The sequence of codewords may be C₂ᵤ, C₁ᵤ, C₁ᵤ, C₄ᵤ, and C₁ᵤ including the initial codeword. If the bit sets 00, 01, 10, and 10 are associated with WTRU 1, the sequence of codewords 1404 may be C₁₁, C₁₁, C₄₁, and C₁₁. Following the approach as described herein, the sequence of codewords 1406 for user 5 may be C₁₅, C₁₅, C₄₅, and C₂₅, and the sequence of codewords 1408 for user 6 may be C₁₆, C₃₆, C₁₆, and C₂₆.

TABLE 1

| Value of bit sets | Transitions | | | |
|---|---|---|---|---|
| 00 | C₁ᵤ, C₂ᵤ | C₃ᵤ, C₄ᵤ | | |
| 01 | C₁ᵤ, C₁ᵤ | C₂ᵤ, C₂ᵤ | C₃ᵤ, C₃ᵤ | C₄ᵤ, C₄ᵤ |
| 10 | C₁ᵤ, C₄ᵤ | C₂ᵤ, C₃ᵤ | | |
| 11 | C₁ᵤ, C₃ᵤ | C₂ᵤ, C₄ᵤ | | |

A sequence of codewords may allow multiple users to use a same set of resources. In the example shown in FIG. 14, six users may use a same set of resources (e.g., indicated by code words C₁ᵤ, C₄ᵤ, C₂ᵤ, and C₅ᵤ.

The resources for codewords may be indicated by a WTRU. The resources may be physical blocks, resource blocks, resource elements, OFDM symbols, subcarriers, and/or the like. For example, a user may use a different codeword or a different set of codewords at a (e.g., each) time instant over 4 resource elements. A receiver may measure a sum of six codewords and/or six sets of codewords at a (e.g., each) time instant. More than six users may be allowed on the same set of resources, e.g., by using Euclidian distance.

By designating different sequence of codewords for a user or WTRU, the six WTRUs or users may transmit data, information bits, bit sets on the same set of resources. In an example, e.g., as shown in FIG. 14, there may be J=6 codebooks, for example, where six different users may be multiplexed on the same resources.

The relationships associating the transitions between the codewords and the values of the bit sets may be determined by the WTRU, signaled over RRC, or predefined. The relationships may be configured by a network over control channels (e.g., uplink control channels or downlink control channels). The relationships may be stored in the WTRU, a network, and/or a network entity.

A receiver may have a multiuser detection algorithm, such as an MPA, for example, to detect the information bits from received transmitted codewords. A receiver may, for example, use two consecutive observation intervals. There may be 2×M observations (e.g., 2×M=8 observations for the example shown in FIG. 14). An MPA algorithm may, for example, based on the observations, estimate the codeword transitions for J users (e.g., J=6 for the example shown in FIG. 14). The MPA may, for example, decode log 2(M) bits for a (e.g., each) user.

The channel response may be approximately constant for the duration of two consecutive observation intervals. The MPA receiver may estimate the codeword transition. Non-coherent detection may occur at the receiver, which may be desirable for massive connectivity systems.

FIG. 15 is an example of differential encoding for code-based NOMA schemes. FIG. 15 shows an example of a sequence of transmitted codewords, for example, using eight codewords per codebook and employing differential encoding of three-tuples. The state-machine in FIG. 15 may include eight states that may be used for eight codewords. The relationships between the value of bit sets and transitions between two of the eight codewords may be used to determine a next codeword from the current codeword. The approaches and processes described herein may apply.

As illustrate in FIG. 15, the initial codeword may be C₁ᵤ. For user 1, the next codeword may be C₁ᵤ if the value of the bit set is 000. C₁ᵤ may be the current codeword indicating the current state. The next bit set value 001 may cause the state machine to transition (e.g., the first transition) from the current state C₁ᵤ to C₄ᵤ. C₄ᵤ may become the current codeword indicating the current state. The next bit set value 110 may cause the state machine to transition (e.g., the second transition) from the current state C₄ᵤ to C₂ᵤ. Following the connections in FIG. 15, a sequence of codewords 1504 that signifies values of four bit sets 000, 001, 110, and 100 may be C₁ᵤ, C₄ᵤ, C₂ᵤ, and C₅ᵤ. The sequence of codewords may be C₁ᵤ, C₁ᵤ, C₄ᵤ, C₂ᵤ, and C₅ᵤ including the initial codeword. Following the approach as described herein, the sequence of codewords 1506 for user 5 may be C₁ᵤ, C₄ᵤ, C₂ᵤ, and C₄ᵤ, and the sequence of codewords 1508 for user 6 may be C₆ᵤ, C₈ᵤ, C₂ᵤ, and C₅ᵤ.

Systems, procedures, and instrumentalities are disclosed for increasing the efficiency and robustness of Non-orthogonal multiple access (NOMA) schemes. Examples are provided for code-domain NOMA schemes using, for example, DFT-s-OFDM (ZT, UW, CP) waveforms, codebook selection for NOMA, DFT based codebook and codeword generation and differential encoding for code-based NOMA schemes.

The processes and instrumentalities described herein may apply in any combination, may apply to other wireless technologies, and for other services.

A WTRU may refer to an identity of the physical device, or to the user's identity such as subscription related identities, e.g., MSISDN (Mobile Station International Subscriber Directory Number), SIP URI (Session Initiation Protocol Uniform Resource Identifier), etc. WTRU may refer to application-based identities, e.g., user names that may be used per application. A WTRU and UE may be used interchangeably.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

1. A method comprising:
storing relationships that associate codewords with values of bit sets;
receiving information bits and converting the information bits into bit sets;
determining codewords associated with the bit sets, wherein the codewords are multi-dimensional modulated discrete fourier transform (DFT) spread codewords, wherein the codewords associated with the bit sets are determined by:
determining a first codeword that is pre-defined for a user,
determining a second codeword associated with a first bit set, wherein the second codeword is determined based on a first relationship between the first codeword and a value of the first bit set,
determining a third codeword associated with a second bit set, wherein the third codeword is determined based on a second relationship between the second codeword and a value of the second bit set, and
transmitting the determined codewords to the user in a frequency domain via a transmit chain.

2. The method of claim 1, wherein the first relationship between the first codeword and the value of the first bit set defines a first transition between the first codeword and the second codeword, and a second relationship between the second codeword and the value of the second bit set defines a second transition between the second codeword and the third codeword.

3. The method of claim 1, wherein the relationships define transitions from a current codeword to a next codeword and continuation of the current codeword based on the values of the bit sets.

4. The method of claim 1, further comprising generating the relationships that associate the codewords with the values of the bit sets.

5. The method of claim 1, wherein the first codeword is associated with a first set of physical resources, the second codeword is associated with a second set of physical resources, and the first set of physical resources and the second set of physical resources are adjacent to each other.

6. The method of claim 5, wherein the physical resources comprise subcarriers.

7. The method of claim 1, wherein the codewords associated with the bit sets are associated with orthogonal frequency division multiplexing (OFDM) symbols.

8. The method of claim 1, wherein the codewords associated with the bit sets are assigned via radio resource control (RRC) signaling.

9. The method of claim 1, wherein consecutive codewords have a different value or a same value depending on an applied relationship.

10. A device comprising:
a memory: and
a processor configured to:
store relationships that associate codewords with values of bit sets;
receive information bits and convert the information bits into bit sets;
determine codewords associated with the bit sets, wherein the codewords associated with the bit sets are multi-dimensional modulated discrete fourier transform (DFT) spread codewords, wherein, to determine the codewords by associated with the bit sets, the processor is configured to:
determine a first codeword that is pre-defined for a user,
determine a second codeword associated with a first bit set, wherein the second codeword is determined based on a first relationship between the first codeword and a value of the first bit set, and
determine a third codeword associated with a second bit set, wherein the third codeword is determined based on a second relationship between the second codeword and a value of the second bit set, and
transmit the determined codewords to the user in a frequency domain via a transmit chain.

11. The device of claim 10, wherein the first relationship between the first codeword and the value of the first bit set defines a first transition between the first codeword and the second codeword, and a second relationship between the second codeword and the value of the second bit set defines a second transition between the second codeword and the third codeword.

12. The device of claim 10, wherein the relationships define transitions from a current codeword to a next codeword and continuation of the current codeword based on the values of the bit sets.

13. The device of claim 10, wherein the processor is further configured to generate the relationships that associate the codewords with the values of the bit sets.

14. The device of claim 10, wherein the first codeword is associated with a first set of physical resources, the second codeword is associated with a second set of physical resources, and the first set of physical resources and the second set of physical resources are adjacent to each other.

15. The device of claim 14, wherein the physical resources comprise subcarriers.

16. The device of claim 10, wherein the codewords associated with the bit sets are associated with orthogonal frequency division multiplexing (OFDM) symbols.

17. The device of claim 10, wherein the codewords associated with the bit sets are assigned via radio resource control (RRC) signaling.

18. The device of claim 10, wherein consecutive codewords have a different value or a same value depending on an applied relationship.

19. The device of claim 10, wherein the multi-dimensional modulated DFT spread codewords are punctured or sparsed.

20. The method of claim 1, wherein the multi-dimensional modulated DFT spread codewords are punctured or sparsed.
